(19) United States
(12) Patent Application Publication
(10) Pub. No.: US 2026/0133104 A1
(43) Pub. Date: May 14, 2026

(54) Method and system for determining critical inelastic strain rate during creep-fatigue damage process

(71) Applicant: China University of Petroleum (East China), Qingdao (CN)

(72) Inventors: Yucai ZHANG, Qingdao (CN); Sidong GUO, Qingdao (CN); Wenchun JIANG, Qingdao (CN); Ming SONG, Qingdao (CN); Xiancheng ZHANG, Shanghai (CN); Shantung TU, Shanghai (CN)

(21) Appl. No.: 19/385,472

(22) Filed: Nov. 11, 2025

(30) Foreign Application Priority Data
Nov. 13, 2024 (CN) 202411612487.9

(51) Int. Cl. G01N 3/08; G01N 3/02

(52) U.S. Cl. CPC G01N 3/08; G01N 3/02; G01N 2203/0062; G01N 2203/0071; G01N 2203/0073; G01N 2203/0226

(57) ABSTRACT

A method and system for determining a critical inelastic strain rate during a creep-fatigue damage process are provided. The method includes: obtaining a plurality of high-temperature equipment materials; under a same temperature condition, conducting a creep test, a fatigue test, and a creep-fatigue interaction test on the high-temperature equipment materials, respectively; establishing a stress relaxation formula based on the creep test result; establishing a fitting equation for an inelastic strain energy density at a failure based on the fatigue test result; establishing a net tensile hysteresis energy-induced fatigue damage equation based on the creep-fatigue interaction test result; and according to a linear cumulative damage rule, determining a creep-fatigue life of the high-temperature equipment materials based on the stress relaxation formula, the fitting equation for an inelastic strain energy density at a failure, and the net tensile hysteresis energy-induced fatigue damage equation.

### CROSS REFERENCE TO RELATED APPLICATION

This patent application claims the benefit and priority of Chinese Patent Application No. 2024116124879, filed with the China National Intellectual Property Administration on Nov. 13, 2024, the disclosure of which is incorporated by reference herein in its entirety as part of the present application.

### TECHNICAL FIELD

The present application relates to the technical field of life prediction for high-temperature equipment, and in particular, to a method and system for determining a critical inelastic strain rate during a creep-fatigue damage process.

### BACKGROUND

In the fields of new energy batteries, aerospace, mechanical chemical engineering, and the like, a large number of mechanical equipment, such as gas engines, aero-engines, heat exchangers, lithium batteries, and fuel cells, operate in extreme environments under high-temperature and high pressure conditions for a long time. During operation, they not only bear the thermal stress generated during steady-state operation and the creep damage caused thereby, but also bear the fatigue damage caused by alternating stress during start-up and shutdown. Such creep-fatigue interaction is one of the main causes for the failure of high-temperature equipment. Therefore, mastering the creep-fatigue failure behavior of high-temperature equipment materials during operation and understanding the variation law of their lives are of great practical significance for the long-cycle reliability design and safe operation of the high-temperature equipment.

### SUMMARY

An objective of the present application is to provide a method and system for determining a critical inelastic strain rate during a creep-fatigue damage process, allowing for more accurate prediction of the creep-fatigue life of a high-temperature equipment material.

To achieve the aforementioned objective, the present application provides the following solutions.

In a first aspect, the present application provides a method for determining a critical inelastic strain rate during a creep-fatigue damage process, including:
obtaining a plurality of identical high-temperature equipment materials;
under a same temperature condition, conducting a creep test, a fatigue test, and a creep-fatigue interaction test on the high-temperature equipment materials, respectively, to obtain a creep test result, a fatigue test result, and a creep-fatigue interaction test result;
establishing a stress relaxation formula based on the creep test result, the stress relaxation formula being configured to calculate a critical stress after correcting a critical inelastic strain rate at an initial stage of strain holding;
establishing a fitting equation for an inelastic strain energy density at a failure based on the fatigue test result, the fitting equation for an inelastic strain energy density at a failure being configured to calculate a corrected inelastic strain energy density dissipation rate and creep damage per cycle;
establishing a net tensile hysteresis energy-induced fatigue damage equation based on the creep-fatigue interaction test result, the net tensile hysteresis energy-induced fatigue damage equation being configured to calculate fatigue damage per cycle; and
determining, according to a linear cumulative damage rule, a creep-fatigue life of the high-temperature equipment materials under creep-fatigue interaction based on the stress relaxation formula, the fitting equation for an inelastic strain energy density at a failure, and the net tensile hysteresis energy-induced fatigue damage equation.

In a second aspect, the present application provides a system for determining a critical inelastic strain rate during a creep-fatigue damage process, including:
a material obtaining module configured to obtain a plurality of identical high-temperature equipment materials;
a test module configured to, under a same temperature condition, conduct a creep test, a fatigue test, and a creep-fatigue interaction test on the high-temperature equipment materials, respectively, to obtain a creep test result, a fatigue test result, and a creep-fatigue interaction test result;
a stress relaxation formula establishment module configured to establish a stress relaxation formula based on the creep test result, the stress relaxation formula being configured to calculate a critical stress after correcting a critical inelastic strain rate at an initial stage of strain holding;
an establishment module for a fitting equation for an inelastic strain energy density at a failure configured to establish a fitting equation for an inelastic strain energy density at a failure based on the fatigue test result, the fitting equation for an inelastic strain energy density at a failure being configured to calculate a corrected inelastic strain energy density dissipation rate and creep damage per cycle;
a net tensile hysteresis energy-induced fatigue damage equation establishment module configured to establish a net tensile hysteresis energy-induced fatigue damage equation based on the creep-fatigue interaction test result, the net tensile hysteresis energy-induced fatigue damage equation being configured to calculate fatigue damage per cycle; and
a life calculation module configured to determine, according to a linear cumulative damage rule, a creep-fatigue life of the high-temperature equipment materials under creep-fatigue interaction based on the stress relaxation formula, the fitting equation for an inelastic strain energy density at a failure, and the net tensile hysteresis energy-induced fatigue damage equation.

According to specific examples provided in the present application, present application discloses the following technical effects:

The present application provides a method and system for determining a critical inelastic strain rate during a creep-fatigue damage process. The method includes: obtaining a plurality of identical high-temperature equipment materials; under a same temperature condition, conducting a creep test, a fatigue test, and a creep-fatigue interaction test on the high-temperature equipment materials, respectively, to obtain corresponding creep test data, fatigue test data, and creep-fatigue interaction test data; establishing a stress relaxation formula based on the obtained creep test data, the stress relaxation formula being configured to calculate a critical stress after preliminary correction of a critical inelastic strain rate; establishing a fitting equation for an inelastic strain energy density at a failure based on the fatigue test data, the fitting equation for an inelastic strain energy density at a failure being configured to calculate a corrected inelastic strain energy density dissipation rate and creep damage per cycle; establishing a net tensile hysteresis energy-induced fatigue damage equation based on the creep-fatigue interaction data, this equation being configured to calculate fatigue damage per cycle; and determining, according to a linear cumulative damage rule, a creep-fatigue life of the high-temperature equipment materials under creep-fatigue interaction based on the stress relaxation formula, the fitting equation for an inelastic strain energy density at a failure, and the net tensile hysteresis energy-induced fatigue damage equation. The present application provides a method for correcting and determining a critical inelastic strain rate during a creep-fatigue damage process to distinguish between ineffective and effective stages of creep damage more accurately. With the corrected cycle-by-cycle creep-fatigue damage accumulation, the overly conservative nature of the existing methods for predicting a creep-fatigue life for creep-fatigue life prediction results for high-temperature equipment materials, thereby achieving more accurate prediction of the creep-fatigue life of the high-temperature equipment materials.

### BRIEF DESCRIPTION OF THE DRAWINGS

To describe the technical solutions in the embodiments of the present application or in the related art more clearly, the following briefly describes the accompanying drawings required for describing the embodiments or the related art. Apparently, the accompanying drawings in the following description show some embodiments of the present application, and a person of ordinary skill in the art may still derive other accompanying drawings from these accompanying drawings without creative efforts.

FIG. 1 is a flowchart of a method for determining a critical inelastic strain rate during a creep-fatigue damage process provided by an embodiment of the present application;

FIG. 2 is a schematic diagram of a loading condition provided by an embodiment of the present application;

FIG. 3 shows a fitted curve for a material stress relaxation test provided by an embodiment of the present application;

FIG. 4 shows a curve of an inelastic strain rate of a material vs time provided by an embodiment of the present application;

FIG. 5 is a schematic diagram of the absence of a critical failure strain energy density provided by an embodiment of the present application;

FIG. 6 is a schematic diagram of the presence of a critical failure strain energy density provided by an embodiment of the present application;

FIG. 7 shows a fitted curve of fatigue damage parameters for a material fatigue test provided by an embodiment of the present application;

FIG. 8 is a comparison diagram of life prediction for a P92 martensitic steel material provided by an embodiment of the present application;

FIG. 9 is a comparison diagram of life prediction for a GH4169 nickel-based alloy material provided by an embodiment of the present application;

FIG. 10 is a comparison diagram of life prediction for a 304 stainless steel (304SS) material provided by an embodiment of the present application;

FIG. 11 is a comparison diagram of life prediction for a Crofer 22 APU stainless steel material provided by an embodiment of the present application; and

FIG. 12 is a comparison diagram of life prediction for an Inconel 625 diffusion-welded joint provided by an embodiment of the present application.

### DETAILED DESCRIPTION OF THE EMBODIMENTS

The technical solutions in the embodiments of the present application will be described clearly and completely below with reference to the accompanying drawings in the embodiments of the present application. Apparently, the described embodiments are merely some rather than all of the embodiments of the present application. All other embodiments derived from the embodiments in the present application by a person of ordinary skill in the art without creative efforts should fall within the protection scope of the present application.

Since the 20th century, researchers worldwide have successively proposed numerous constitutive models to predict the creep-fatigue life of high-temperature equipment materials. With advancements in fatigue theory and fracture mechanics, combined with failure analysis of high-temperature equipment, it has been gradually recognized that damage mechanisms involve not only independent creep damage and fatigue damage but also a damage interaction mechanism between creep and fatigue. The high-temperature fatigue damage mechanism is related not only to time-independent plastic deformation but also to time-dependent creep and oxidation effects. Complex creep-fatigue loading conditions pose significant challenges to the life prediction for high-temperature equipment materials. Currently, creep-fatigue life prediction models for high-temperature components can be categorized by theoretical framework into types: creep-fatigue life prediction methods based on Manson-Coffin equation, based on a differentiation method, and based on the linear damage accumulation criterion. The life prediction models based on the Manson-Coffin equation are mainly represented by the frequency separation model proposed by Coffin. This model takes the cyclic frequencies in tension and compression for the first time, enhancing its adaptability to various creep-fatigue loading conditions. However, this model neglects the stress welding effect during compressive holding times and the mean stress effect during asymmetric loading. The life prediction models based on the differentiation method are primarily represented by the strain range partitioning method. This method attributes creep-fatigue failure of a material to inelastic strain, and involves calculating the damage corresponding to components of different properties using the Manson-Coffin equation by partitioning the inelastic strain range into four distinct components, and superimposing the damage according to specific criteria to obtain the creep-fatigue life. Nevertheless, this method has defects and limitations in predicting creep-fatigue life under low strain control range and long-life conditions. Within the theoretical framework of the linear damage accumulation criterion, the creep-fatigue life prediction model based on the strain energy density dissipation method, which accounts for anelastic recovery, has been widely adopted due to its clear physical significance, strong operability, and fewer easily obtainable parameters. However, this model fails to consider the differences in anelastic recovery rates during the initial hold period for different strain ranges under cyclic softening/hardening of high-temperature equipment materials. Moreover, approximating the creep damage in the half-life cycle to the creep damage per cycle leads to overly conservative life prediction results.

An objective of the present application is to provide a method and system for determining a critical inelastic strain rate during a creep-fatigue damage process, allowing for more accurate prediction of the creep-fatigue life of a high-temperature equipment material.

To make the above objectives, features, and advantages of the present application more apparent and easier to understand, the present application will be further described in detail with reference to the accompanying drawings and specific embodiments.

### Embodiment 1

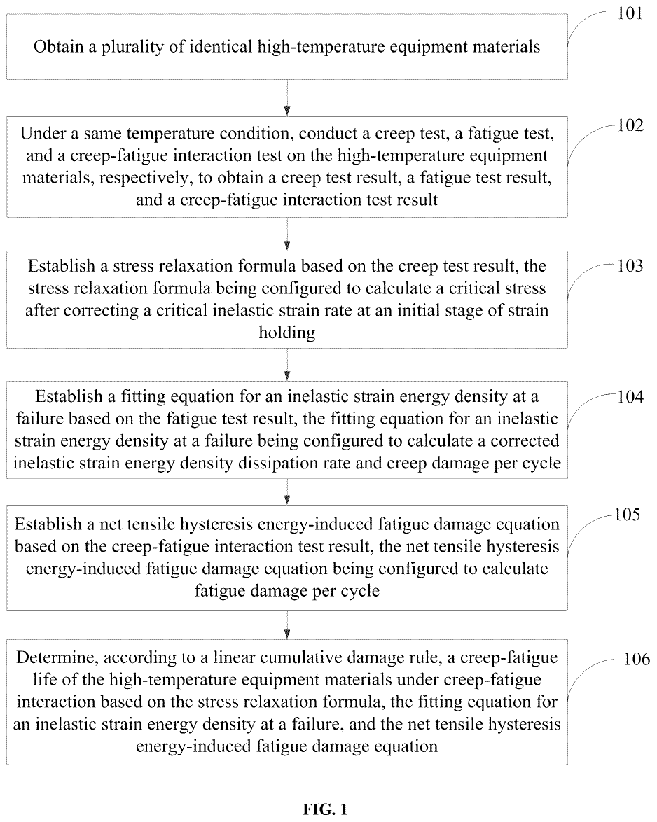

As shown in FIG. 1, this embodiment provides a method for determining a critical inelastic strain rate during a creep-fatigue damage process, including the following steps.

In step 101, a plurality of identical high-temperature equipment materials are obtained.

In step 102, under a same temperature condition, a creep test, a fatigue test, and a creep-fatigue interaction test are conducted on the high-temperature equipment materials, respectively, to obtain a creep test result, a fatigue test result, and a creep-fatigue interaction test result.

In step 103, a stress relaxation formula is established based on the creep test result. The stress relaxation formula is configured to calculate a critical stress after correcting a critical inelastic strain rate at an initial stage of strain holding.

In step 104, a fitting equation for an inelastic strain energy density at a failure is established based on the fatigue test result. The fitting equation for an inelastic strain energy density at a failure is configured to calculate a corrected inelastic strain energy density dissipation rate and creep damage per cycle.

In step 105, a net tensile hysteresis energy-induced fatigue damage equation is established based on the creep-fatigue interaction test result. The net tensile hysteresis energy-induced fatigue damage equation is configured to calculate fatigue damage per cycle.

In step 106, a creep-fatigue life of the high-temperature equipment materials under creep-fatigue interaction is determined according to a linear cumulative damage rule based on the stress relaxation formula, the fitting equation for an inelastic strain energy density at a failure, and the net tensile hysteresis energy-induced fatigue damage equation.

In some embodiments, step 101 may be specifically as follows.

Among the plurality of identical high-temperature equipment materials obtained, the high-temperature equipment material may be a P92 martensitic steel material, a GH4169 nickel-based alloy material, a 304 stainless steel (304SS) material, a Crofer 22 APU stainless steel material, and an Inconel 625 diffusion-welded joint.

In some embodiments, step 102 may be specifically as follows.

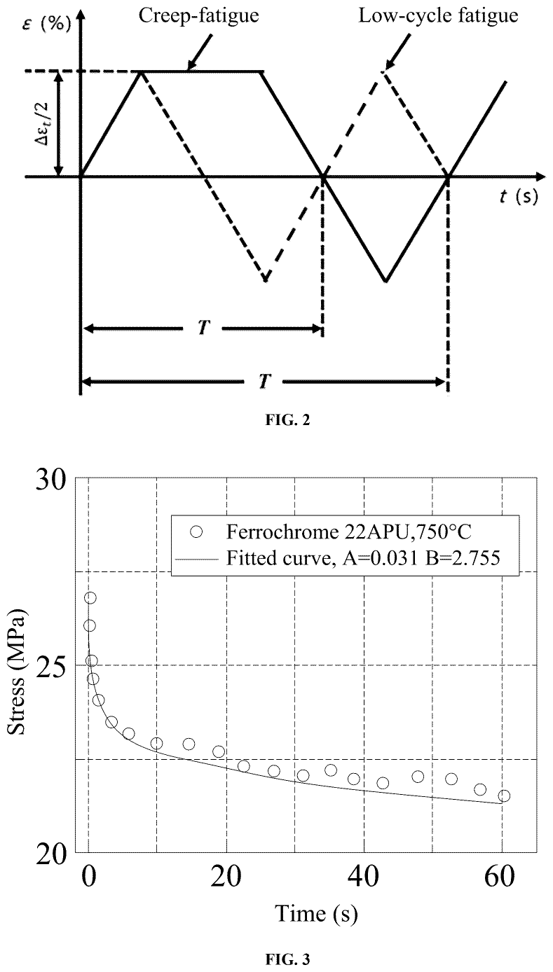

Under the same temperature condition, the creep test, the fatigue test, and the creep-fatigue interaction test are conducted on the high-temperature equipment materials, respectively. The methods for implementing the creep test, the fatigue test, and the creep-fatigue interaction test are not described redundantly here. FIG. 2 shows an actual loading condition. As shown in FIG. 2, a same loading amplitude and a same loading rate are used in the fatigue test and the creep-fatigue interaction test.

In some embodiments, step 103 may be specifically as follows.

The stress relaxation formula is established based on the creep test result. The stress relaxation formula shows a function relationship of stress per cycle vs time for the high-temperature equipment material within a maximum tensile holding time, expressed as follows:

$$σ ( t ) = {σ}_{0} - ( A \cdot lg Δ {ε}_{pp} + B ) \cdot lg ( 1 + t ) \qquad ( 1 )$$

where σ₀ represents an instantaneous (maximum) stress at a maximum tensile strain in a half-life cycle; Δεₚₚ represents a plastic strain range; t represents a half-maximum tensile holding time; and A and B represent parameters for fitting Jeong stress relaxation formula.

For example, FIG. 3 shows a fitted curve for a stress relaxation test on the Crofer 22 APU stainless steel material of high-temperature equipment at 750° C. This fitted curve is obtained by fitting parameters of a stress relaxation curve in the strain holding stage of the half-life cycle. During fitting, the constant A is set to 0.031, the constant B is set to 2.755, and the strain condition is set to 0.5%. It can be seen from FIG. 3 that the stress decreases continuously with the increase of time.

In particular, the critical stress after correcting the critical inelastic strain rate at the initial stage of strain holding is calculated. The specific process is as follows.

1) The critical inelastic strain rate of the material within the maximum tensile holding time is calculated according to the stress relaxation formula. By differentiating the formula (1), a stress relaxation rate is calculated by:

$${\dot{ε}}_{in} = - \frac{\dot{σ}}{E} = \frac{A \cdot lg {Δε}_{pp} + B}{E \cdot ( 1 + t ) \cdot ln 10} \qquad ( 2 )$$

where \dot{ε}ᵢₙ represents an inelastic strain rate; \dot{σ} represents derivation of the formula (1); and E represents an elastic modulus of the material at a creep-fatigue test temperature.

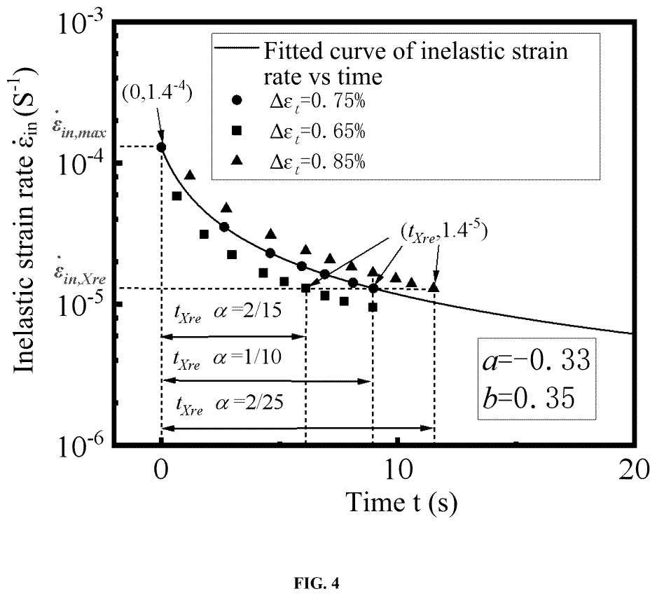

Based on the effective creep damage theory during stress relaxation, the critical inelastic strain rate is determined from a stress relaxation rate curve obtained by calculation by the formula (2), and is then substituted into the formula (1) to obtain the corrected critical strain rate. The following formulas are used:

$${\dot{ε}}_{in , Xre} = α {\dot{ε}}_{in , max} \qquad ( 3 )$$

$$α = ( {a Δ ε}_{p} + b ) \qquad ( 4 )$$

where \dot{ε}_{in, Xre} represents the critical inelastic strain rate; \dot{ε}_{in,max} represents a maximum inelastic strain rate at the initial stage of stress relaxation; Δεₚ, represents a strain control range; a, a, and b represent material parameters independent of a cycle, and the specific calculation method for them is as shown in FIG. 4 for example.

For example, in FIGS. 4, 0.65%, 0.75%, and 0.85% are the strain conditions of the creep-fatigue test; t_{Xre} represents the time taken for the high-temperature equipment material to reach the critical inelastic strain rate during strain holding; (0, 1.4-4) is the maximum inelastic strain rate \dot{ε}_{in,max} corresponding to the holding time of zero; and (t_{Xre}, 1.4-5) is the critical inelastic strain rate \dot{ε}_{in,Xre} corresponding to no creep damage at the anelastic recovery stage. In this case, under different strain conditions, the desired parameter a is different for \dot{ε}_{in,max} decreasing to \dot{ε}_{in,Xre} by one order of magnitude of time during anelastic recovery. According to three groups of different strain conditions, Δεₚ and α may be calculated by the formula (4), α is set to −0.33 and b is set to 0.35. Then, the values of α and \dot{ε}_{in,Xre} under other strain conditions are calculated by the formula (4). From FIG. 4, a relationship of the critical inelastic strain rate changing with strain conditions at the anelastic recovery stage of the cyclically softened material can be observed.

2) The time

$${t}_{Xre}^{( j )}$$

taken for the high-temperature equipment material to reach the critical inelastic strain rate during strain holding is calculated by formula (5), expressed as follows:

$${t}_{Xre}^{( j )} = - ( \frac{A \cdot lg Δ {ε}_{pp}^{( j )} + B}{{\dot{ε}}_{in , Xre} \cdot E \cdot ln 10} + 1 ) . \qquad ( 5 )$$

3) The stress relaxation formula (1) is corrected, and the corrected stress relaxation formula σ_{Xnew} (t) is expressed as follows:

$${σ}_{Xnew} ( t ) = {σ}_{0} - ( A \cdot lg Δ {ε}_{pp} + B ) \cdot lg ( 1 + t + {t}_{Xre} ) . \qquad ( 6 )$$

4) t_{Xre} calculated by the formula (5) is substituted in the formula (1) to obtain the corrected critical stress σ_{Xre} with consideration of the anelastic recovery of the material, expressed as follows:

$${σ}_{Xre}^{( j )} = {σ}_{0} - ( A \cdot lg Δ {ε}_{pp}^{( j )} + B ) \cdot lg ( 1 + {t}_{Xre}^{( j )} ) . \qquad ( 7 )$$

In some embodiments, step 104 may be specifically as follows.

The fitting equation for an inelastic strain energy density at a failure is established based on the result of the creep test. This equation reflects a function relationship between an inelastic strain energy density w_{f} at a failure and an inelastic strain energy density dissipation rate \dot{W}ᵢₙ for the high-temperature equipment material with log-log coordinates. The specific function relationship is as follows:

$${w}_{f} ( {\dot{w}}_{in}^{{n}_{1}} , T ) = φ \cdot {\dot{w}}_{in}^{{n}_{1}} \qquad ( 8 )$$

where T represents a temperature; and n₁ and φ represent model parameters related to a temperature and a material, respectively.

In particular, formulas for calculating the inelastic strain energy density w_{f} at the failure and the inelastic strain energy density dissipation rate \dot{w}ᵢₙ are respectively as follows:

$${w}_{f} = σ \cdot ln ( 1 + {ε}_{f} ) ; \qquad ( 9 )$$

$$and$$

$${\dot{w}}_{in} = \frac{σ \cdot ln ( 1 + {ε}_{f} )}{{t}_{R}} . \qquad ( 10 )$$

In particular, the corrected inelastic strain energy density dissipation rate is calculated. The specific process is as follows.

The corrected inelastic strain energy density w_{in,Xnew} with consideration of creep-fatigue anelastic recovery is calculated according to a hysteresis loop in a half-life cycle by the following formula:

$${w}_{in , Xnew} = \frac{{( {σ}_{Xre} + {σ}_{m} )}^{2} - {( {σ}_{Xnew} + {σ}_{m} )}^{2}}{2 E} \qquad ( 11 )$$

where σₘ represents the average stress of the material in the half-life cycle.

The formula (11) is subjected to derivation to obtain the corrected inelastic strain energy density dissipation rate w_{in,Xnew}. The formula for the corrected inelastic strain energy density dissipation rate is as follows:

$${\dot{w}}_{in , Xnew} = - \frac{{\dot{σ}}_{Xnew}}{E} ( {σ}_{Xnew} + {σ}_{m} ) \qquad ( 12 )$$

where \dot{σ}_{new} represents the corrected stress relaxation rate per cycle for the high-temperature equipment material during the maximum tensile holding time, and a calculation formula thereof is as follows:

$${\dot{σ}}_{Xnew} = - \frac{A \cdot lg Δ {ε}_{pp}^{( j )} + B}{( 1 + {t}_{re}^{( j )} + t )} \qquad ( 13 )$$

The formula (7) and the formula (13) are substituted into the formula (12) to derive:

$${\dot{w}}_{in , Xnew} = \frac{{M}^{( j )}}{1 + {t}_{Xre}^{( j )} + t} - \frac{{N}^{( j )}}{1 + {t}_{Xre}^{( j )} + t} \cdot lg ( 1 + {t}_{Xre}^{( j )} + t ) \qquad ( 14 )$$

where M and N are intermediate variables defined for facilitating writing of the formula (14), which are respectively as follows:

$${M}^{( j )} = \frac{( {σ}_{Xre}^{( j )} + {σ}_{m}^{( j )} ) ( A \cdot lg Δ {ε}_{pp}^{( j )} + B )}{E ln 10} ; \qquad ( 15 )$$

$$and$$

$${N}^{( j )} = \frac{{( A lg Δ {ε}_{pp}^{( j )} + B )}^{2}}{E ln 10} . \qquad ( 16 )$$

The step of calculating the creep damage per cycle is as follows:

It is first to determine whether there is a critical inelastic strain energy density at a failure through the creep test, and then the creep damage is calculated using different equations according to the determination result. The specific step is as follows:

When there is no critical failure strain energy density w_{f0} in the creep test, the creep damage per cycle in the j-th cycle is calculated by formula (17):

$${d}_{c 1}^{( j )} = {{\int }_{0}}^{{t}_{h} - {t}_{Xre}^{( j )}} \frac{{\dot{w}}_{in , Xnew}}{{w}_{f} ( {w}_{in , new} , T )} dt \qquad ( 17 )$$

where

$${d}_{c 1}^{( j )}$$

represents the creep damage per cycle in the j-th cycle when there is no critical inelastic strain energy density at a failure; and tₕ represents the maximum strain holding time.

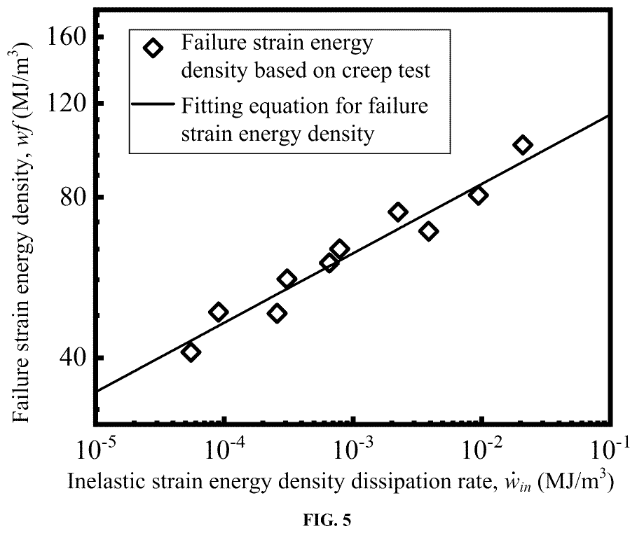

In fitting the parameters of the formula (8), if the value of w_{f} always increases with the increase of \dot{w}ᵢₙ, it indicates that w_{f} of the material at this temperature has no upper plateau value, i.e., no critical failure strain energy density w_{f0}. For example, FIG. 5 shows the case where there is no critical inelastic strain energy density at a failure. It is not difficult to find that the inelastic strain energy density w_{f} at a failure based on the creep test and the inelastic strain energy density dissipation rate \dot{w}ᵢₙ are positively correlated.

The formulas (8) and (14) are substituted into the formula (17) to obtain the cumulative creep damage

$${D}_{c 1}^{( i )}$$

in the absence of the critical failure strain energy density w_{f0} in the creep test:

$${D}_{c 1}^{( i )} = {\sum }_{j = 1}^{i} {d}_{c 1}^{( j )} = {\sum }_{j = 1}^{i} {\int }_{0}^{{t}_{h} - {t}_{Xre}^{( j )}} {\frac{1}{φ} [ \frac{{M}^{( j )}}{1 + {t}_{Xre}^{( j )} + t} - \frac{{N}^{( j )}}{1 + {t}_{Xre}^{( j )} + t} \cdot lg ( 1 + {t}_{Xre}^{( j )} + t ) ]}^{1 - {n}_{1}} dt . \qquad ( 18 )$$

When there is the critical failure strain energy density w_{f0} in the creep test, the cumulative creep damage per cycle is calculated by formula (20). The derivation process of formula (20) is as follows:
for the creep damage

$${d}_{c 2}^{( j )}$$

per cycle in the j-th cycle when there is a critical inelastic strain energy density at a failure,

$${d}_{c 2}^{( j )} = {\int }_{0}^{{t}_{h} - {t}_{Xre}^{( j )}} [ \frac{{\dot{w}}_{in , Xnew}}{{w}_{f} ( {\dot{w}}_{in , Xnew ,} T )} - \frac{{\dot{w}}_{in , Xnew}}{{w}_{f 0}} ] dt \qquad ( 19 )$$

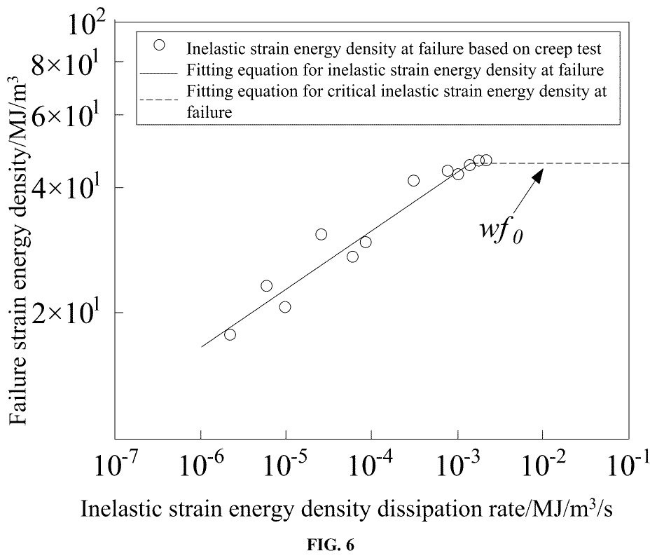

In the process of fitting the parameters of the formula (8), if w_{f} increases with the increase of \dot{w}ᵢₙ first, but when \dot{w}ᵢₙ exceeds a certain value, the value of w_{f} remains unchanged, it indicates that w_{f} of the material at this temperature has the upper plateau value, i.e., the critical inelastic strain energy density w_{f0} at the failure. For example, FIG. 6 shows the case where there is the critical inelastic strain energy density at the failure. It is not difficult to find that the inelastic strain energy density w_{f} at the failure based on the creep test increases with the increase of the inelastic strain energy density dissipation rate \dot{w}ᵢₙ first, and when \dot{w}ᵢₙ continues to increase to exceed a certain value, the value of w_{f} remains unchanged.

The formulas (8) and (14) are substituted into the formula (19) to obtain the cumulative creep damage

$${D}_{c 2}^{( i )}$$

in the presence of the critical failure strain energy density w_{f0} in the creep test:

$${D}_{c 2}^{( i )} = {\sum }_{j = 1}^{i} {d}_{c 2}^{( j )} = {\sum }_{j = 1}^{i} {\int }_{0}^{{t}_{h} - {t}_{Xre}^{( j )}} [ \frac{\frac{{M}^{( j )}}{1 + {t}_{X r e}^{( j )} + t} - \frac{{N}^{( j )}}{1 + {t}_{X r e}^{( j )} + t} \cdot lg ( 1 + {t}_{X r e}^{( j )} + t )}{min ( φ \cdot {\dot{w}}_{in , Xnew} , {w}_{f 0} )} - \frac{\frac{{M}^{( j )}}{1 + {t}_{X r e}^{( j )} + t} - \frac{{N}^{( j )}}{1 + {t}_{X r e}^{( j )} + t} \cdot lg ( 1 + {t}_{X r e}^{( j )} + t )}{{w}_{f 0} ( t )} ] dt \qquad ( 20 )$$

where

$${D}_{c 2}^{( i )}$$

represents the cumulative creep damage for the first i cycles, and

$${d}_{c 2}^{( j )}$$

represents the single creep damage for the j-th cycle; min(·) represents minimization; min (φ·\dot{w}_{in,new}, w_{f0}) represents the minimum failure strain energy density of the material, and its specific calculation formula is as follows:

$$min ( φ \cdot {\dot{w}}_{in , new ,} {w}_{f 0} ) = min \{ φ \cdot {[ \frac{{M}^{( j )}}{1 + {t}_{X r e}^{( j )} + t} - \frac{{N}^{( j )}}{1 + {t}_{X r e}^{( j )} + t} \cdot lg ( 1 + {t}_{X r e}^{( j )} + t ) ]}^{{n}_{1}} , {w}_{f 0} \} . \qquad ( 21 )$$

In some embodiments, step 105 may be specifically as follows.

Parameters a₂ and b₂ are fitted by using the half-life net tensile hysteresis energy of the high-temperature equipment material obtained in the fatigue test, and the formula for the fatigue damage per cycle is established as follows:

$${D}_{f}^{( i )} = {\sum }_{j = 1}^{i} {d}_{f}^{( j )} = {\sum }_{j = 1}^{i} \frac{1}{{a}_{2} \cdot {[ {σ}_{0}^{( j )} Δ {ε}_{p p}^{( j )} ]}^{- {b}_{2}}} \qquad ( 22 )$$

where

$${D}_{f}^{( i )}$$

represents cumulative fatigue damage up to the i-th cycle;

$${d}_{f}^{( j )}$$

represents fatigue damage in the j-th cycle;

$${σ}_{0}^{( j )}$$

represents a peak stress in the j-th cycle;

$$Δ {ε}_{p p}^{( j )}$$

represents the plastic strain range in the-th cycle; and a₂ and b₂ represent material parameters independent of a cycle.

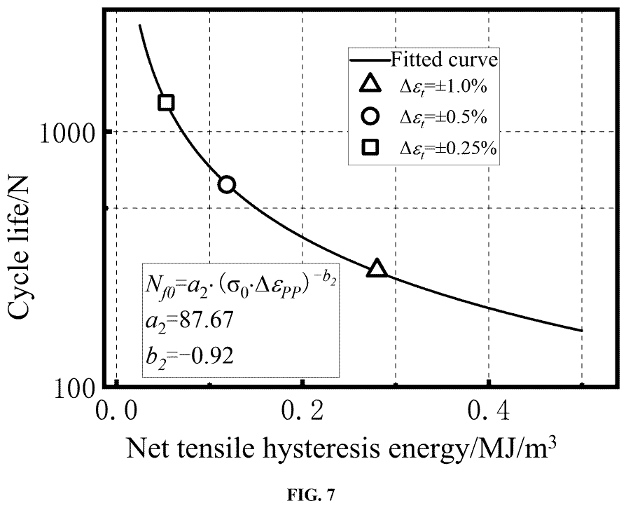

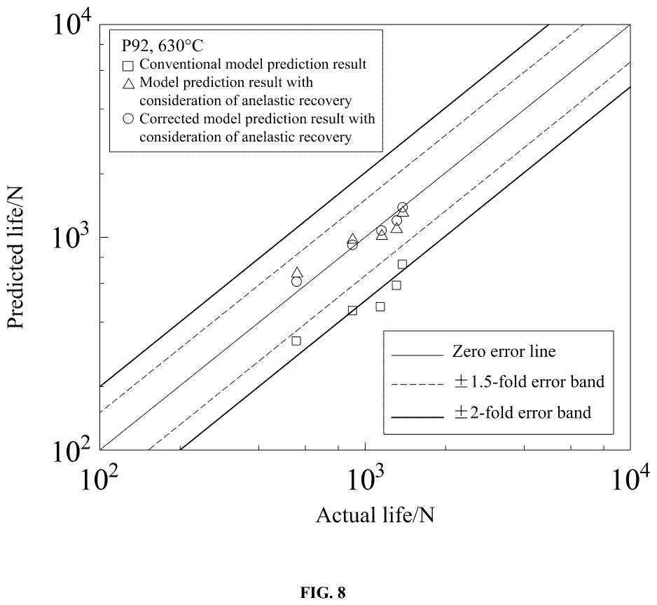

For example, FIG. 7 shows a fitted curve of the half-life net tensile hysteresis energy from the pure fatigue test of Crofer 22 APU material for high-temperature equipment at 750° C. In the fatigue test, three different strain control ranges of ±1%, ±0.5%, and ±0.25% are used. This fitted curve is obtained by fitting the parameters of the half-life cycle curve from the fatigue test, with the constant a₂ set to 87.67 and the constant b₂ set to −0.92.

In some embodiments, step 106 may be specifically as follows.

When the creep-fatigue life of the high-temperature equipment materials under creep-fatigue interaction is determined according to the linear cumulative damage rule based on the stress relaxation formula, the fitting equation for an inelastic strain energy density at a failure, and the net tensile hysteresis energy-induced fatigue damage equation, creep-fatigue life equations are used in different cases.

In the absence of the critical failure strain energy density, the formula for calculating the creep-fatigue life is as follows:

$${D}_{f}^{( i )} + {D}_{c 1}^{( i )} = 1 . \qquad ( 23 )$$

According to the failure criterion, the value of i when

$${D}_{f}^{( i )} + {D}_{c 1}^{( i )} = 1$$

is the predicted creep-fatigue life value under the corresponding working conditions.

In the presence of the critical failure strain energy density, the formula for calculating the creep-fatigue life is as follows:

$${D}_{f}^{( i )} + {D}_{c 2}^{( i )} = 1 . \qquad ( 24 )$$

According to the failure criterion, the value of i when

$${D}_{f}^{( i )} + {D}_{c 2}^{( i )} = 1$$

is the predicted creep-fatigue life value under the corresponding working conditions.

In some embodiments, the prediction of life under creep-fatigue interaction is performed on the P92 martensitic steel material, the GH4169 nickel-based alloy material, the 304SS material, the Crofer 22 APU stainless steel material, and the Inconel 625 diffusion-welded joint in the present application as follows.

### Example 1: Prediction of Life Under Creep-Fatigue Interaction for Martensitic Steel Material (P92) of High-Temperature Equipment at 630° C.

Only the life of the martensitic steel material at 630° C. is studied, and the constant 4=21.6 is obtained using the formula (8). By investigating the relationship between the inelastic strain energy density at the failure and the inelastic strain energy density dissipation rate at 630° C., the critical inelastic strain energy density w_{f0} at the failure=52 is identified. In the creep-fatigue test at 630° C., strain control ranges of ±0.2% and ±0.3% are used to calculate the constants 4=−0.69 and B=10.95 dependent on material characteristics, and the stress relaxation curve (i.e., the formula (1)) is established. Combined with ABAQUS finite element simulation and subroutines,

$${t}_{Xre}^{( j )}$$

is calculated oy the formulas (2), (3), (4), and (5). According to literature research, the elastic modulus of this material at 630° C. is E=94 GPa. All material constants required for the creep-fatigue life prediction model for the P92 material at 630° C. are obtained.

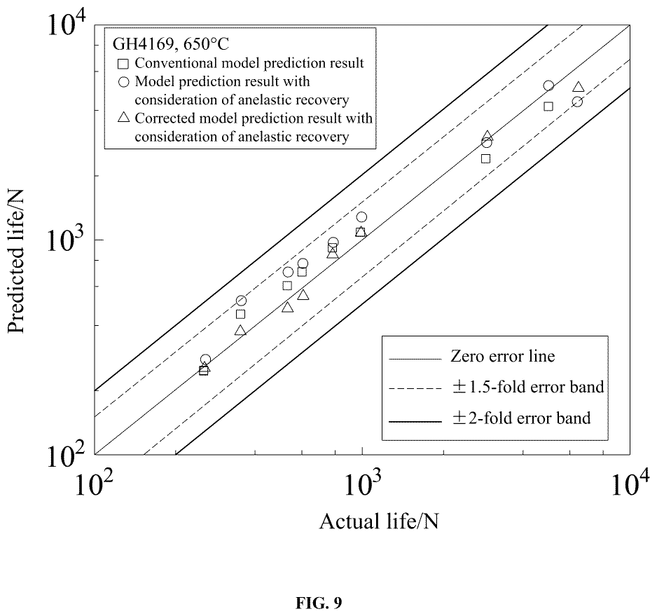

In the present application, the fatigue damage per cycle for a certain total strain range is calculated by the formula (22). Due to the presence of the critical failure strain energy density, the creep damage per cycle is calculated by the formula (20) in combination with ABAQUS finite element simulation and subroutines. Finally, using the linear cumulative damage rule, the predicted lives for different total strain ranges and holding times are calculated by the formula (24), and compared with the actual experimental results. The results are shown in FIG. 8.

It can be seen from the results in FIG. 8 that all predicted lives calculated in the present application not only fall within the 1.5-fold error band, but also the experimental results are closer to the prediction results. It is not difficult to find that compared with existing creep-fatigue life prediction models, the life prediction capability of the present application is significantly improved. Thus, the method for determining a critical inelastic strain rate during a creep-fatigue damage process described in the present application can better predict the creep-fatigue life of P92 at 630° C.

### Example 2: Prediction of Life Under Creep-Fatigue Interaction for GH4169 Nickel-Based Alloy Material of High-Temperature Equipment at 650° C.

Only the life of GH4169 at 650° C. is studied, and the constant φ=114.8 is obtained using the formula (8). By investigating the relationship between the inelastic strain energy density at the failure and the inelastic strain energy density dissipation rate at 650° C., the critical inelastic strain energy density w_{f0} at the failure=46 is identified. In the creep-fatigue test at 650° C., strain control ranges of ±1.0%, ±1.2%, ±1.6%, and ±2.0% are used to calculate the constants A=13.3 and B=17.4 dependent on material characteristics, and the stress relaxation curve (i.e., the formula (1)) is established. Combined with ABAQUS finite element simulation and subroutines,

$${t}_{Xre}^{( j )}$$

is calculated by the formulas (2), (3), (4), and (5). According to literature research, the elastic modulus of this material at 650° C. is E=171 GPa. All material constants required for the creep-fatigue life prediction model for the GH4169 material at 650° C. are obtained.

In the present application, the fatigue damage per cycle for a certain total strain range is calculated by the formula (22). Due to the presence of the critical failure strain energy density, the creep damage per cycle is calculated by the formula (20) in combination with ABAQUS finite element simulation and subroutines. Finally, using the linear cumulative damage rule, the predicted lives for different total strain ranges and holding times are calculated by the formula (24), and compared with the actual experimental results. The results are shown in FIG. 9.

It can be seen from the results in FIG. 9 that all predicted lives calculated in the present application not only fall within the 1.5-fold error band, but also the experimental results are closer to the prediction results. In contrast, the prediction results of existing models only lie around the 1.5-fold error band. Therefore, compared with existing creep-fatigue life prediction models, the life prediction capability of the present application is significantly improved. It is not difficult to find that the method for determining a critical inelastic strain rate during a creep-fatigue damage process described in the present application can better predict the creep-fatigue life of GH4169 at 650° C.

### Example 3: Prediction of Life Under Creep-Fatigue Interaction for 304SS of High-Temperature Equipment at 650° C.

Only the life of 304SS at 650° C. is studied, and the constant 4=154.11 is obtained using the formula (8). By investigating the relationship between the inelastic strain energy density at the failure and the inelastic strain energy density dissipation rate at 650° C., no critical inelastic strain energy density at the failure is identified. In the creep-fatigue test at 650° C., strain control ranges of ±0.5% and ±2.0% are used to calculate the constants A=45.55 and B=129.19 dependent on material characteristics, and the stress relaxation curve (i.e., the formula (1)) is established. Combined with ABAQUS finite element simulation and subroutines,

$${t}_{Xre}^{( j )}$$

is calculated by the formulas (2), (3), (4), and (5). According to literature research, the elastic modulus of this material at 650° C. is E=193 GPa. All material constants required for the creep-fatigue life prediction model for the 304SS material at 650° C. are obtained.

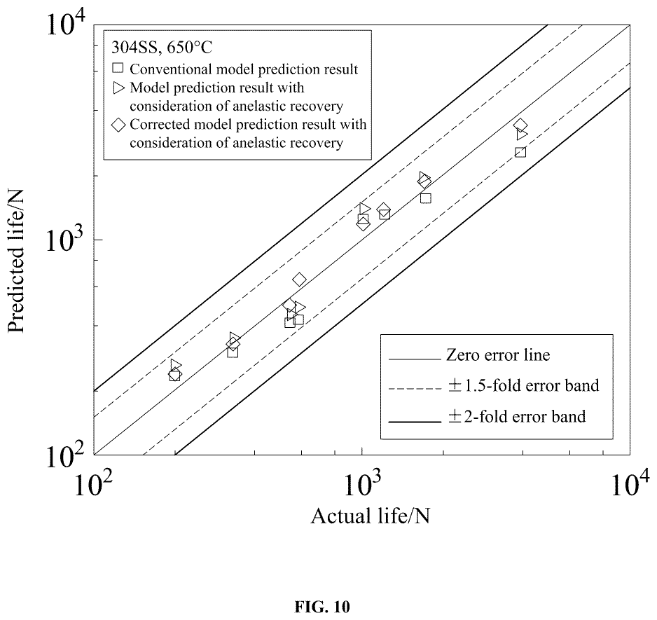

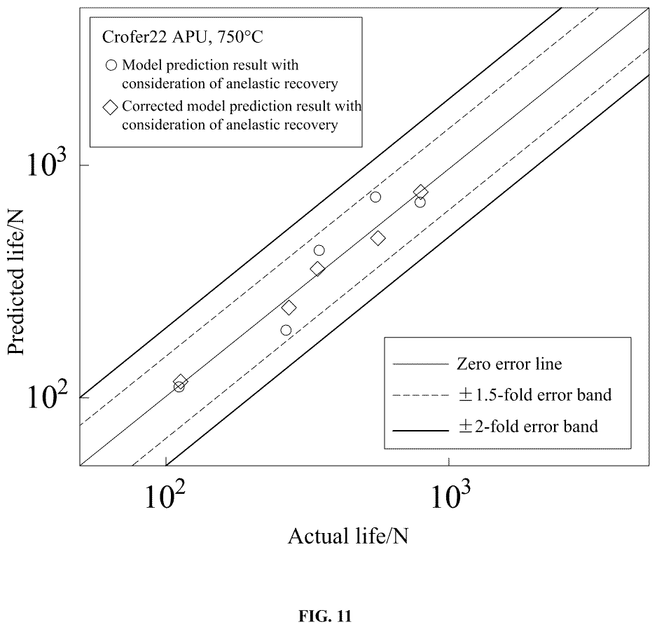

In the present application, the fatigue damage per cycle for a certain total strain range is calculated by the formula (22). Due to the presence of the critical failure strain energy density, the creep damage per cycle is calculated by the formula (18) in combination with ABAQUS finite element simulation and subroutines. Finally, using the linear cumulative damage rule, the predicted lives for different total strain ranges and holding times are calculated by the formula (23), and compared with the actual experimental results. The results are shown in FIG. 10.

It can be seen from the results in FIG. 10 that all predicted lives calculated in the present application not only fall within the 1.5-fold error band, but also the experimental results are closer to the prediction results. In contrast, the prediction results of existing models only lie around the 1.5-fold error band. Therefore, compared with existing creep-fatigue life prediction models, the life prediction capability of the present application is significantly improved. It is not difficult to find that the method for determining a critical inelastic strain rate during a creep-fatigue damage process described in the present application can better predict the creep-fatigue life of 304SS at 650° C.

### Example 4: Prediction of Life Under Creep-Fatigue Interaction for Crofer 22 APU Stainless Steel of High-Temperature Equipment at 750° C.

Only the life of the Crofer 22 APU at 750° C. is studied, and the constant φ=39.337 is obtained using the formula (8). By investigating the relationship between the inelastic strain energy density at the failure and the inelastic strain energy density dissipation rate at 750° C., no critical inelastic strain energy density at the failure is identified. In the creep-fatigue test at 750° C., strain control ranges of ±0.25% and ±0.5% are used to calculate the constants A=0.031 and B=2.77 dependent on material characteristics, and the stress relaxation curve (i.e., the formula (1)) is established. Combined with ABAQUS finite element simulation and subroutines,

$${t}_{Xre}^{( j )}$$

is calculated by the formulas (2), (3), (4), and (5). The tested elastic modulus of this material at 750° C. is E=0.239 GPa. All material constants required for the creep-fatigue life prediction model for the Crofer 22 APU material at 750° C. are obtained.

In the present application, the fatigue damage per cycle for a certain total strain range is calculated by the formula (22). Due to the presence of the critical failure strain energy density, the creep damage per cycle is calculated by the formula (18) in combination with Crofer 22 APU finite element simulation and subroutines. Finally, using the linear cumulative damage rule, the predicted lives for different total strain ranges and holding times are calculated by the formula (23), and compared with the actual experimental results. The results are shown in FIG. 11.

It can be seen from the results in FIG. 11 that all predicted lives calculated in the present application not only fall within the 1.5-fold error band, but also the experimental results are closer to the prediction results. In contrast, the prediction results of existing models only lie around the 1.5-fold error band. Therefore, compared with existing creep-fatigue life prediction models, the life prediction capability of the present application is significantly improved. It is not difficult to find that the method for determining a critical inelastic strain rate during a creep-fatigue damage process described in the present application can better predict the creep-fatigue life of Crofer 22 APU at 750° C.

### Example 5: Prediction of Life Under Creep-Fatigue Interaction for Inconel 625 Diffusion-Welded Joint of High-Temperature Equipment at 650° C.

Only the life of the Inconel 625 diffusion-welded joint at 650° C. is studied, and the constant φ=10.5 is obtained using the formula (8). By investigating the relationship between the inelastic strain energy density at the failure and the inelastic strain energy density dissipation rate at 650° C., no critical inelastic strain energy density at the failure is identified. In the creep-fatigue test at 650° C., strain control ranges of +0.25% and +0.3% are used to calculate the constants A=6.08 and B=19.5 dependent on material characteristics, and the stress relaxation curve (i.e., the formula (1)) is established. Combined with ABAQUS finite element simulation and subroutines,

$${t}_{Xre}^{( j )}$$

is calculated by the formulas (2), (3), (4), and (5). According to literature research, the elastic modulus of this material at 650° C. is E=179417 MPa. All material constants required for the creep-fatigue life prediction model for the Inconel 625 diffusion-welded joint at 650° C. are obtained.

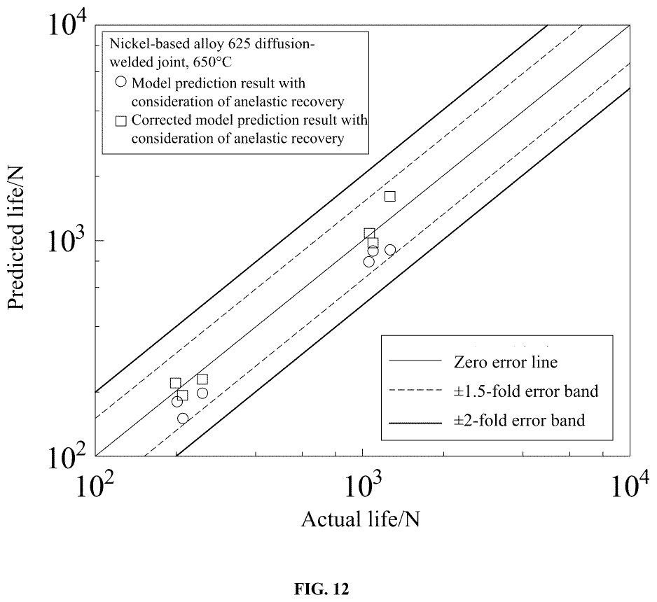

In the present application, the fatigue damage per cycle for a certain total strain range is calculated by the formula (22). Due to the presence of the critical failure strain energy density, the creep damage per cycle is calculated by the formula (18) in combination with ABAQUS finite element simulation and subroutines. Finally, using the linear cumulative damage rule, the predicted lives for different total strain ranges and holding times are calculated by the formula (23), and compared with the actual experimental results. The results are shown in FIG. 12.

It can be seen from the results in FIG. 12 that all predicted lives calculated in the present application not only fall within the 1.5-fold error band, but also the experimental results are closer to the prediction results. In contrast, the prediction results of existing models only lie around the 1.5-fold error band. Therefore, compared with existing creep-fatigue life prediction models, the life prediction capability of the present application is improved. Especially the prediction capability for cyclically softened/hardened materials under different loading conditions is significantly enhanced. It can thus be concluded that the method for determining a critical inelastic strain rate during a creep-fatigue damage process described in the present application can well predict the creep-fatigue life of Inconel 625 at 650° C.

### Embodiment 2

This embodiment provides a system for determining a critical inelastic strain rate during a creep-fatigue damage process, including:
a material obtaining module configured to obtain a plurality of identical high-temperature equipment materials;
a test module configured to, under a same temperature condition, conduct a creep test, a fatigue test, and a creep-fatigue interaction test on the high-temperature equipment materials, respectively, to obtain a creep test result, a fatigue test result, and a creep-fatigue interaction test result;
a stress relaxation formula establishment module configured to establish a stress relaxation formula based on the creep test result, the stress relaxation formula being configured to calculate a critical stress after correcting a critical inelastic strain rate at an initial stage of strain holding;
an establishment module for a fitting equation for an inelastic strain energy density at a failure configured to establish a fitting equation for an inelastic strain energy density at a failure based on the fatigue test result, the fitting equation for an inelastic strain energy density at a failure being configured to calculate a corrected inelastic strain energy density dissipation rate and creep damage per cycle;
a net tensile hysteresis energy-induced fatigue damage equation establishment module configured to establish a net tensile hysteresis energy-induced fatigue damage equation based on the creep-fatigue interaction test result, the net tensile hysteresis energy-induced fatigue damage equation being configured to calculate fatigue damage per cycle; and
a life calculation module configured to determine, according to a linear cumulative damage rule, a creep-fatigue life of the high-temperature equipment materials under creep-fatigue interaction based on the stress relaxation formula, the fitting equation for an inelastic strain energy density at a failure, and the net tensile hysteresis energy-induced fatigue damage equation.

The technical characteristics of the above embodiments can be employed in arbitrary combinations. To provide a concise description of these embodiments, all possible combinations of all the technical characteristics of the above embodiments may not be described. However, these combinations of the technical characteristics should be construed as falling within the scope defined by the specification as long as no contradiction occurs.

Several examples are used herein for illustration of the principles and embodiments of the present application. The description of the foregoing examples is used to help illustrate the method of the present application and the core principles thereof. In addition, those of ordinary skill in the art can make various modifications in terms of specific embodiments and scope of application in accordance with the teachings of the present application. In conclusion, the content of the present specification shall not be construed as a limitation to present application.

What is claimed is:

1. A method for determining a critical inelastic strain rate during a creep-fatigue damage process, comprising:
obtaining a plurality of identical high-temperature equipment materials;
under a same temperature condition, conducting a creep test, a fatigue test, and a creep-fatigue interaction test on the high-temperature equipment materials, respectively, to obtain a creep test result, a fatigue test result, and a creep-fatigue interaction test result;
establishing a stress relaxation formula based on the creep test result, the stress relaxation formula being configured to calculate a critical stress after correcting a critical inelastic strain rate at an initial stage of strain holding;
establishing a fitting equation for an inelastic strain energy density at a failure based on the fatigue test result, the fitting equation for an inelastic strain energy density at a failure being configured to calculate a corrected inelastic strain energy density dissipation rate and creep damage per cycle;
establishing a net tensile hysteresis energy-induced fatigue damage equation based on the creep-fatigue interaction test result, the net tensile hysteresis energy-induced fatigue damage equation being configured to calculate fatigue damage per cycle; and
determining, according to a linear cumulative damage rule, a creep-fatigue life of the high-temperature equipment materials under creep-fatigue interaction based on the stress relaxation formula, the fitting equation for an inelastic strain energy density at a failure, and the net tensile hysteresis energy-induced fatigue damage equation.

2. The method for determining a critical inelastic strain rate during a creep-fatigue damage process according to claim 1, wherein the stress relaxation formula is as follows:
$$σ ( t ) = {σ}_{0} - ( A \cdot lg Δ {ε}_{pp} + B ) \cdot lg ( 1 + t ) ;$$
wherein σ₀ represents an instantaneous stress at a maximum tensile strain in a half-life cycle; Δεₚₚ represents a plastic strain range; t represents a half-maximum tensile holding time; and A and B represent parameters for fitting Jeong stress relaxation formula.

3. The method for determining a critical inelastic strain rate during a creep-fatigue damage process according to claim 2, wherein a formula for calculating the critical stress after correcting the critical inelastic strain rate at the initial stage of strain holding is as follows:
$${σ}_{Xre}^{( j )} = {σ}_{0} - ( A \cdot lg Δ {ε}_{pp}^{( j )} + B ) \cdot lg ( 1 + {t}_{Xre}^{( j )} ) ;$$
wherein
$$Δ {ε}_{pp}^{( j )}$$
represents a plastic strain range in a j-th cycle; and
$${t}_{Xre}^{( j )}$$
represents a time taken to reach the critical inelastic strain rate during strain holding in the j-th cycle.

4. The method for determining a critical inelastic strain rate during a creep-fatigue damage process according to claim 3, wherein the fitting equation for an inelastic strain energy density at a failure is as follows:
$${w}_{f} ( {\dot{w}}_{in} , T ) = φ \cdot {\dot{w}}_{in}^{{n}_{1}} ;$$
wherein w_{f} represents an inelastic strain energy density at a failure; \dot{W}ᵢₙ represents an inelastic strain energy density dissipation rate; T represents a temperature; and n₁ and φ represent model parameters related to a temperature and a material, respectively.

5. The method for determining a critical inelastic strain rate during a creep-fatigue damage process according to claim 4, wherein formulas for calculating the corrected inelastic strain energy density dissipation rate and the creep damage per cycle are as follows:
$${\dot{w}}_{in , Xnew} = \frac{{M}^{( j )}}{1 + {t}_{Xre}^{( j )} + t} - \frac{{N}^{( j )}}{1 + {t}_{Xre}^{( j )} + t} \cdot lg ( 1 + {t}_{Xre}^{( j )} + t ) ,$$
by which the corrected inelastic strain energy density dissipation rate is calculated; and
$${D}_{c 1}^{( i )} = {\sum }_{j = 1}^{i} {d}_{c 1}^{( j )} = {\sum }_{j = 1}^{i} {\int }_{0}^{{t}_{h} - {t}_{Xre}^{( j )}} {\frac{1}{{B}_{1} exp ( - \frac{Q}{RT} )} [ \frac{{M}^{( j )}}{1 + {t}_{Xre}^{( j )} + t} - \frac{{N}^{( j )}}{1 + {t}_{Xre}^{( j )} + t} \cdot lg ( 1 + {t}_{Xre}^{( j )} + t ) ]}^{1 - {n}_{1}} dt$$
$$and$$
$${D}_{c 2}^{( i )} = {\sum }_{j = 1}^{i} {d}_{c 2}^{( j )} = {\sum }_{j = 1}^{i} {\int }_{0}^{{t}_{h} - {t}_{Xre}^{( j )}} [ \frac{\frac{{M}^{( j )}}{1 + {t}_{Xre}^{( j )} + t} - \frac{{N}^{( j )}}{1 + {t}_{Xre}^{( j )} + t} \cdot lg ( 1 + {t}_{Xre}^{( j )} + t )}{min ( φ \cdot {\dot{w}}_{in , Xnew} , {w}_{f 0} )} - \frac{\frac{{M}^{( j )}}{1 + {t}_{Xre}^{( j )} + t} - \frac{{N}^{( j )}}{1 + {t}_{Xre}^{( j )} + t} \cdot lg ( 1 + {t}_{Xre}^{( j )} + t )}{{w}_{f 0} ( T )} ] dt ,$$
by which the creep damage per cycle is calculated,
wherein M^{(j)} and N^{(j)} are intermediate variables:
$${M}^{( j )} = \frac{( {σ}_{Xre}^{( j )} + {σ}_{m} ) ( A \cdot lg Δ {ε}_{pp}^{( j )} + B )}{E ln 10} and$$
$${N}^{( j )} = \frac{{( A lg Δ {ε}_{pp}^{( j )} + B )}^{2}}{E ln 10} ;$$
σₘ represents a mean stress in the half-life cycle;
$${t}_{Xre}^{( j )}$$
represents the time taken to reach the critical inelastic strain rate during strain holding in the j-th cycle; E represents an elastic modulus of the material at a temperature;
$${σ}_{Xre}^{( j )}$$
represents a critical stress in the j-th cycle;
$${D}_{c 1}^{( i )}$$
represents cumulative creep damage for first i cycles in the absence of a critical failure strain energy density;
$${d}_{c 1}^{( j )}$$
represents single creep damage for the j-th cycle in the absence of the critical failure strain energy density; tₕ represents a tensile holding time;
$${D}_{c 2}^{( i )}$$
represents cumulative creep damage for the first i cycles in the presence of the critical failure strain energy density; and
$${d}_{c 2}^{( j )}$$
represents single creep damage for the j-th cycle in the absence of the critical failure strain energy density.

6. The method for determining a critical inelastic strain rate during a creep-fatigue damage process according to claim 1, wherein a formula for calculating the fatigue damage per cycle is as follows:
$${D}_{f}^{( i )} = {Σ}_{j = 1}^{i} {d}_{f}^{( j )} = {Σ}_{j = 1}^{i} \frac{1}{{a}_{2} \cdot {[ {σ}_{0}^{( j )} Δ {ε}_{pp}^{( j )} ]}^{- {b}_{2}}} ;$$
wherein
$${D}_{f}^{( i )}$$
represents cumulative fatigue damage up to the i-th cycle;
$${d}_{f}^{( j )}$$
represents fatigue damage in the j-th cycle;
$${σ}_{0}^{( j )}$$
represents a peak stress in the j-th cycle;
$$Δ {ε}_{pp}^{( j )}$$
represents the plastic strain range in the j-th cycle; and a₂ and b₂ represent material parameters independent of a cycle.

7. The method for determining a critical inelastic strain rate during a creep-fatigue damage process according to claim 6, wherein the determining, according to a linear cumulative damage rule, a creep-fatigue life of the high-temperature equipment materials under creep-fatigue interaction based on the stress relaxation formula, the fitting equation for an inelastic strain energy density at a failure, and the net tensile hysteresis energy-induced fatigue damage equation comprises:
in the absence of a critical failure strain energy density, calculating a creep-fatigue life according to a formula
$${D}_{f}^{( i )} + {D}_{c 1}^{( i )} = 1 ;$$
and
in the presence of the critical failure strain energy density, calculating the creep-fatigue life according to a formula
$${D}_{f}^{( i )} + {D}_{c 2}^{( i )} = 1 ;$$
wherein
$${D}_{c 1}^{( i )}$$
represents the cumulative creep damage for the first i cycles in the absence of the critical failure strain energy density; and
$${D}_{c 2}^{( i )}$$
represents the cumulative creep damage for the first i cycles in the presence of the critical failure strain energy density.

8. The method for determining a critical inelastic strain rate during a creep-fatigue damage process according to claim 1, wherein the high-temperature equipment materials comprise a P92 martensitic steel material, a GH4169 nickel-based alloy material, a 304 stainless steel (304SS) material, a Crofer 22 APU stainless steel material, and an Inconel 625 diffusion-welded joint.

9. The method for determining a critical inelastic strain rate during a creep-fatigue damage process according to claim 1, wherein a same loading amplitude and a same loading rate are used in the fatigue test and the creep-fatigue interaction test.

10. A system for determining a critical inelastic strain rate during a creep-fatigue damage process, comprising:
a material obtaining module configured to obtain a plurality of identical high-temperature equipment materials;
a test module configured to, under a same temperature condition, conduct a creep test, a fatigue test, and a creep-fatigue interaction test on the high-temperature equipment materials, respectively, to obtain a creep test result, a fatigue test result, and a creep-fatigue interaction test result;
a stress relaxation formula establishment module configured to establish a stress relaxation formula based on the creep test result, the stress relaxation formula being configured to calculate a critical stress after correcting a critical inelastic strain rate at an initial stage of strain holding;
an establishment module for a fitting equation for an inelastic strain energy density at a failure configured to establish a fitting equation for an inelastic strain energy density at a failure based on the fatigue test result, the fitting equation for an inelastic strain energy density at a failure being configured to calculate a corrected inelastic strain energy density dissipation rate and creep damage per cycle;
a net tensile hysteresis energy-induced fatigue damage equation establishment module configured to establish a net tensile hysteresis energy-induced fatigue damage equation based on the creep-fatigue interaction test result, the net tensile hysteresis energy-induced fatigue damage equation being configured to calculate fatigue damage per cycle; and
a life calculation module configured to determine, according to a linear cumulative damage rule, a creep-fatigue life of the high-temperature equipment materials under creep-fatigue interaction based on the stress relaxation formula, the fitting equation for an inelastic strain energy density at a failure, and the net tensile hysteresis energy-induced fatigue damage equation.
